(19) United States
(12) Patent Application Publication
(10) Pub. No.: US 2012/0299278 A1
(43) Pub. Date: Nov. 29, 2012

(54) AIRBAG FOR FRONT PASSENGER'S SEAT

(75) Inventor: Osamu Fukawatase, Miyoshi-shi Aichi-ken (JP)

(73) Assignee: TOYOTA JIDOSHA KABUSHIKI KAISHA, Toyota-shi Aichi-ken (JP)

(21) Appl. No.: 13/576,601

(22) PCT Filed: Jun. 4, 2010
(86) PCT No.: PCT/JP2010/059565

§ 371 Date: Aug. 1, 2012

(51) Int. Cl. B60R 21/16

(52) U.S. Cl. 280/743.1

(57) ABSTRACT

An object of the present invention is to make it possible to manufacture many types of airbags corresponding to vehicles by merely changing a sewing line, while using panels in common. An airbag for a front passenger's seat is structured by using an inner panel that is sewn together opposingly in a vehicle transverse direction, wherein an outer panel that is provided so as to nip the inner panel from both sides in the vehicle transverse direction, and is provided with a left side bag portion that is positioned at a vehicle transverse direction left side, and a right side bag portion that is positioned at a vehicle transverse direction right side. A shape of a concave portion at a passenger side between the left side bag portion and the right side bag portion is set by a sewing line of sewing together the inner panel.

### TECHNICAL FIELD

The present invention relates to an airbag for a front passenger's seat.

### Background Art

There are disclosed airbags that have a left side airbag and a right side airbag that inflate respectively at the left side and the right side of the front of a passenger, and at which a concave shape is provided between the left side airbag and the right side airbag (see Patent Document 1 and Patent Document 2).

### [Patent Document 1] Japanese Patent Application Laid-Open No. 2004-314933

### [Patent Document 2] Japanese Patent Application Laid-Open No. 2006-103654

### SUMMARY OF INVENTION

### Technical Problem

However, in the above-described prior art, because the airbag is formed by numerous panels being sewn, a large amount of panels is used, and the sewing work as well is complex. Furthermore, with regard to the shape of the airbag when deployment is completed, because the shape that is required differs depending on the vehicle, the panel shapes and dimensions must be changed per vehicle so as to conform to the requirements, and it is particularly difficult to change the depth of the concave shape per vehicle.

In view of the above-described circumstances, an object of the present invention is to make it such that many types of airbags corresponding to vehicles can be manufactured by merely changing a sewing line, while using panels in common.

### Solution to Problem

A first aspect of the present invention is structured by using an inner panel that is sewn together opposingly in a vehicle transverse direction, and an outer panel that is provided so as to nip the inner panel from both sides in the vehicle transverse direction, wherein a left side bag portion that is positioned at a vehicle transverse direction left side, and a right side bag portion that is positioned at a vehicle transverse direction right side, are provided, and a shape of a concave portion at a passenger side between the left side bag portion and the right side bag portion is set by a sewing line of sewing together the inner panel.

In the airbag for a front passenger's seat relating to the first aspect, at the time of manufacturing the airbag, the shape of the concave portion at the passenger side between the left side bag portion and the right side bag portion, which shape differs per vehicle, can be set by the sewing line of sewing together the inner panel. Therefore, many types of airbags corresponding to vehicles can be manufactured by merely changing the sewing line, while using the panels in common.

In a second aspect, in the airbag for a front passenger's seat relating to the first aspect, the inner panel is a single base cloth, and is folded in two toward the passenger side with a central portion in the vehicle transverse direction being a center, and a left side base cloth, that is positioned at a vehicle transverse direction left side, and a right side base cloth, that is positioned at a vehicle transverse direction right side, are sewn along the sewing line in a state of opposing one another in the vehicle transverse direction, and the outer panel is a single base cloth that has an outer shape corresponding to the inner panel and in whose central portion a gas supply opening for inflation is formed, and is sewn along an outer peripheral edge portion of the inner panel that is folded in two.

In the airbag for a front passenger's seat relating to the second aspect, the inner panel and the outer panel are each a single base cloth, and the airbag for a front passenger's seat is structured by sewing these. Therefore, the number of panels can be suppressed, and the structure can be simplified. Further, because the respective sewings can be carried out in a plane, the sewing work is easy. Therefore, the manufacturing cost can be greatly reduced.

In a third aspect, in the airbag for a front passenger's seat relating to the second aspect, a lateral hole that is long in a left-right direction is formed in a central portion, in the vehicle transverse direction, of the inner panel in an unfolded state before sewing, and the sewing line is set at a region between the lateral hole and the outer peripheral edge portion.

In the airbag for a front passenger's seat relating to the third aspect, the lateral hole is formed in the inner panel, and the sewing line is set at the region between this lateral hole and the outer peripheral edge portion. Therefore, the used amount of the base cloth that structures the inner panel is reduced, the manufacturing cost is reduced more, and the folded-up dimension at usual times is made to be small, and the loadability into a vehicle can be improved.

In a fourth aspect, in the airbag for a front passenger's seat relating to the third aspect, an inner surface of a vehicle transverse direction left side and an inner surface of a vehicle transverse direction right side at the outer panel are connected by a restricting member that restricts an amount of inflation and deployment in the vehicle transverse direction.

In the airbag for a front passenger's seat relating to the fourth aspect, the amount of inflation and deployment of the vehicle transverse inflation at the time of inflation is restricted by the restricting member that connects the inner surface of the vehicle transverse direction left side and the inner surface of the vehicle transverse direction right side at the outer panel. Therefore, the airbag for a front passenger's seat can be inflated and deployed appropriately toward the passenger side while conserving the amount of gas that is supplied.

In a fifth aspect, in the airbag for a front passenger's seat relating to any one aspect of the first through fourth aspects, a depth of the concave portion at the passenger side at a time of inflation and deployment is set to be greater at a vehicle lower region than at a vehicle upper region.

In the airbag for a front passenger's seat relating to the fifth aspect, the depth of the concave portion at the passenger side at the time of inflation and deployment differs at the vehicle vertical direction positions, and is set to be greater at the vehicle lower region than at the vehicle upper region. Therefore, a passenger of a large build is restrained by a relatively shallow portion of the concave portion, and a passenger of a small build is restrained by a relatively deep portion of the concave portion. Therefore, a passenger can be restrained appropriately in accordance with the build of the passenger.

### Advantageous Effects of Invention

As described above, in accordance with the airbag for a front passenger's seat relating to the first aspect of the present invention, the excellent effect is obtained that it can be made possible to manufacture many types of airbags corresponding to vehicles by merely changing the sewing line, while using the panels in common.

In accordance with the airbag for a front passenger's seat relating to the second aspect, the excellent effect is obtained that the manufacturing cost can be greatly reduced.

In accordance with the airbag for a front passenger's seat relating to the third aspect, the excellent effects are obtained that the manufacturing cost is reduced more, and the folded-up dimension at usual times is made to be small, and the loadability into a vehicle can be improved.

In accordance with the airbag for a front passenger's seat relating to the fourth aspect, the excellent effect is obtained that the airbag for a front passenger's seat can be inflated and deployed appropriately toward the passenger side while conserving the amount of gas that is supplied.

In accordance with the airbag for a front passenger's seat relating to the fifth aspect, the excellent effect is obtained that a passenger can be restrained appropriately in accordance with the build of the passenger.

### BRIEF DESCRIPTION OF DRAWINGS

FIG. 1 is a perspective view showing an airbag for a front passenger's seat that is inflated and deployed from within an instrument panel.

FIG. 2 is a development showing an inner panel before sewing.

FIG. 3 is a perspective view showing the inner panel that is folded in two with a central portion being the center, and is sewn at a sewing line.

FIG. 4 is a development showing an outer panel before sewing.

FIG. 5 is a perspective view showing an example in which a restricting member is provided at the outer panel.

FIG. 6 is a perspective view showing the airbag for a front passenger's seat in an inflated and deployed state.

FIG. 7 is a sectional schematic drawing along arrow 7-7 in FIG. 6, showing a vehicle lower region of a concave portion at the airbag for a front passenger's seat.

FIG. 8 is a sectional schematic drawing along arrow 8-8 in FIG. 6, showing a vehicle upper region of the concave portion at the airbag for a front passenger's seat.

FIG. 9 is a side view showing, at the airbag for a front passenger's seat that is inflated and deployed, a state in which a passenger of a large build is restrained by the vehicle upper region of the concave portion, and a passenger of a small build is restrained by the vehicle lower region of the concave portion.

### DESCRIPTION OF EMBODIMENTS

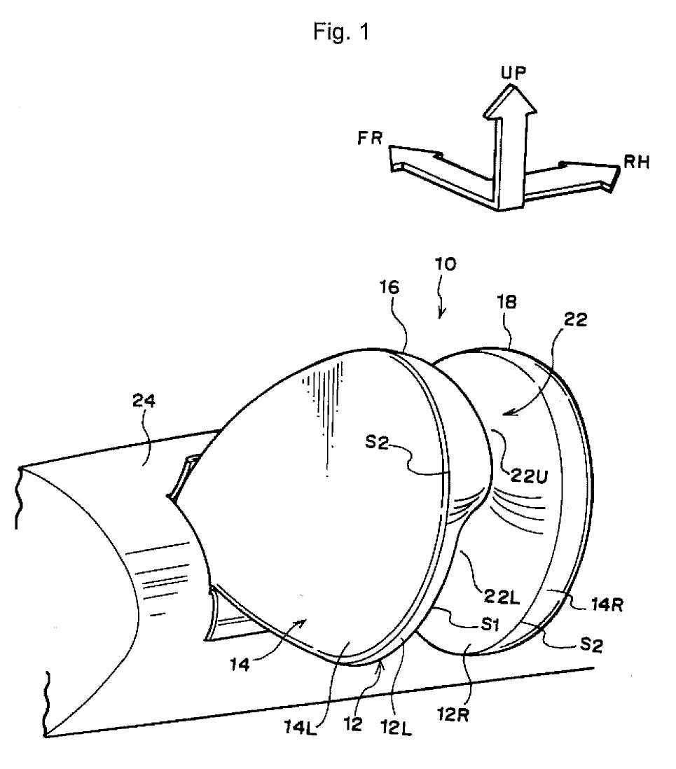

Embodiments of the present invention are described hereinafter on the basis of the drawings. In FIG. 1, an airbag 10 for a front passenger's seat relating to the present embodiment is structured by using an inner panel 12 and an outer panel 14, and a left side bag portion 16, that is positioned at the vehicle transverse direction left side, and a right side bag portion 18, that is positioned at the vehicle transverse direction right side, are provided thereat.

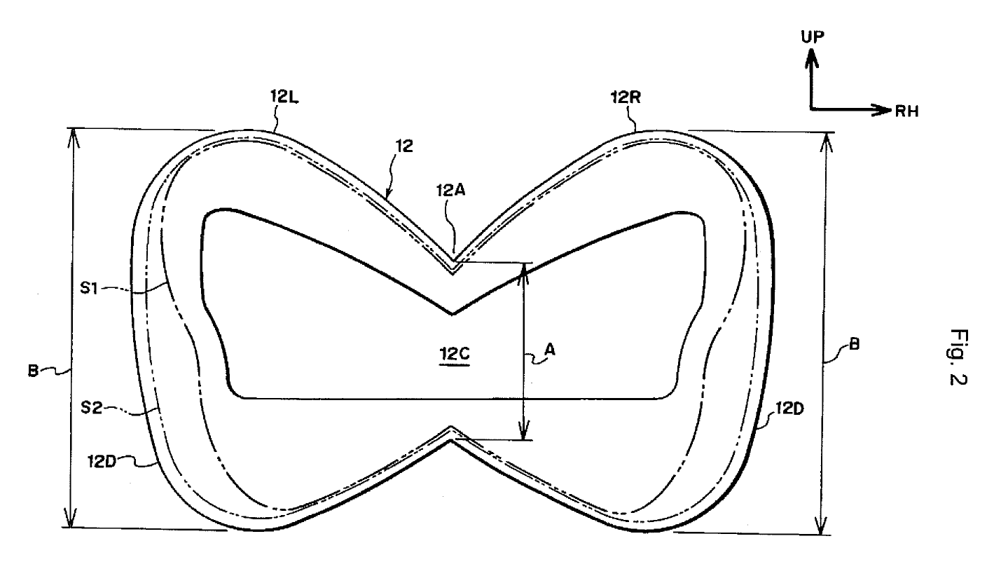

As shown in FIG. 2, the inner panel 12 is a single base cloth that is sewn together opposingly in the vehicle transverse direction, and, in an unfolded state before sewing, is formed in a double-leaf-shaped shape that is symmetrical to the left and the right. A vertical dimension A of a central portion 12A is smaller than vertical dimensions B of the left and right both end portions. Here, the vertical dimensions B of the left and right both end portions are the respective maximum vertical dimensions at a left side base cloth 12L, that is positioned at the vehicle transverse direction left side, and a right side base cloth 12R, that is positioned at the vehicle transverse direction right side. Note that the vertical dimension B at the left side base cloth 12L and the vertical dimension B at the right side base cloth 12R do not necessarily have to be the same.

A lateral hole 12C, that is long in the left-right direction, is formed in the central portion in the vehicle transverse direction of the inner panel 12 in the unfolded state before sewing. With regard to the shape of this lateral hole 12C, the respective vertical dimensions at the left side base cloth 12L and the right side base cloth 12R are enlarged so as to, as much as possible, follow along a sewing line S1 that is described later. Due thereto, the used amount of the base cloth that structures the inner panel 12 is reduced, and the amount of the base cloth that is used at the airbag 10 for a front passenger's seat in a completed state can be reduced, more so than in a case in which the lateral hole 12C is made to be a substantial rectangle that is symmetrical to the left and the right. Further, by using the base cloth from which the lateral hole 12C portion is cut and using it as a reinforcing cloth or the like, the base cloth is utilized effectively, and a reduction in cost also can be devised. Moreover, the folded-up dimension at usual times can be made to be even smaller.

Note that the size of the lateral hole 12C may be enlarged upward and downward and the edges of this lateral hole 12C may be set even closer to the sewing line S1. Further, the lateral hole 12C may be a substantial rectangle or another shape. Conversely, there may be a structure that is not provided with the lateral hole 12C.

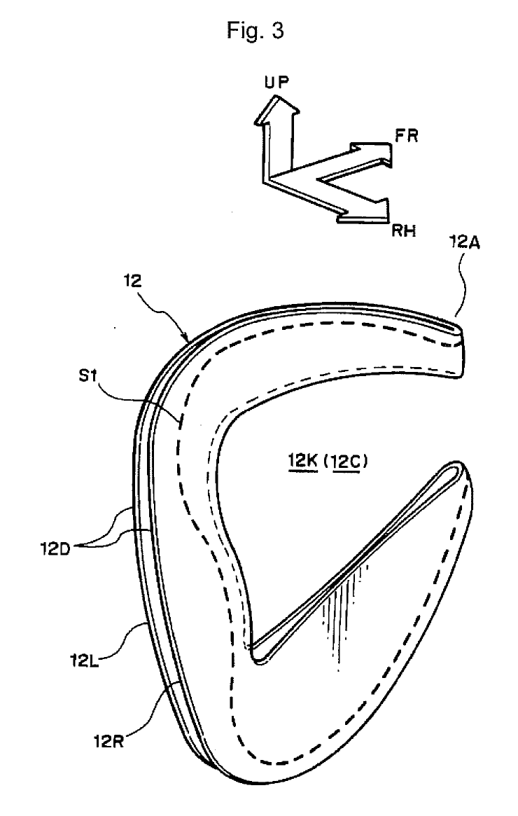

As shown in FIG. 3, the inner panel 12 is folded in two toward the passenger side with the central portion in the vehicle transverse direction being the center, and the left side base cloth 12L, that is positioned at the vehicle transverse direction left side, and the right side base cloth 12R, that is positioned at the vehicle transverse direction right side, are sewn along the sewing line S1 in a state of facing one another in the vehicle transverse direction. This sewing line S1 is set at the region between the lateral hole 12C and an outer peripheral edge portion 12D. In the present embodiment, by changing the position of this sewing line S1, many types of airbags corresponding to vehicles can be manufactured while using the inner panel 12 and the outer panel 14 in common. Due to the inner panel 12 being folded in two, the lateral hole 12C of the inner panel 12 becomes a cut-out portion 12K.

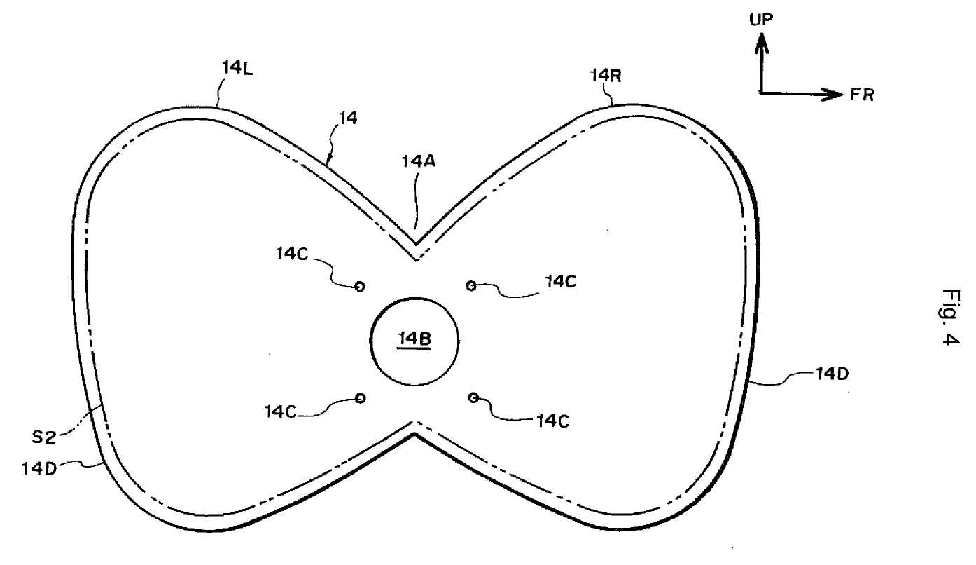

In FIG. 4, the outer panel 14 is a single base cloth that has an outer shape corresponding to the inner panel 12, and in which a gas supply opening 14B for inflation is formed in a central portion 14A. For example, the outer panel 14 is similar to the outer shape of the inner panel 12, and has a left side base cloth 14L, that is positioned at the vehicle transverse direction left side, and a right side base cloth 14R, that is positioned at the vehicle transverse direction right side, and is formed in a double-leaf-shaped shape that is symmetrical to the left and the right. In the present embodiment, the shape of the gas supply opening 14B is circular in correspondence with a disk-type inflator (not shown), but when a cylinder-type inflator (not shown) is used, the shape of the gas supply opening 14B is formed in a rectangle for example. Four holes 14C, that are formed at the periphery of the gas supply opening 14B, are for the passage of bolts at the time when the inflator and the airbag 10 for a front passenger's seat are fixed to an airbag case or the like (not shown).

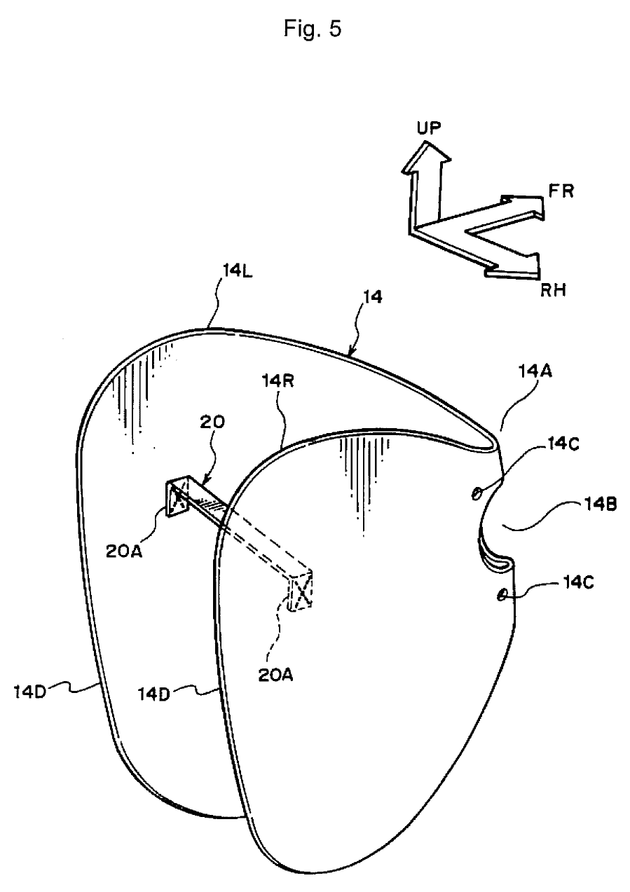

As shown in FIG. 5, the inner surface of the left side base cloth 14L and the inner surface of the right side base cloth 14R at the outer panel 14 may be connected by a restricting member 20 that restricts the amount of inflation and deployment in the vehicle transverse direction. This restricting member 20 is, for example, a tether that is non-extensible, and, at both ends 20A thereof, is sewn to the inner surface of the left side base cloth 14L and the inner surface of the right side base cloth 14R. The restricting member 20 in the present embodiment is provided at a position that traverses the cut-out portion 12K (see FIG. 3) in the vehicle transverse direction at the time of inflation and deployment of the airbag 10 for a front passenger's seat. This is in order to avoid interference between the restricting member 20 and the inner panel 12.

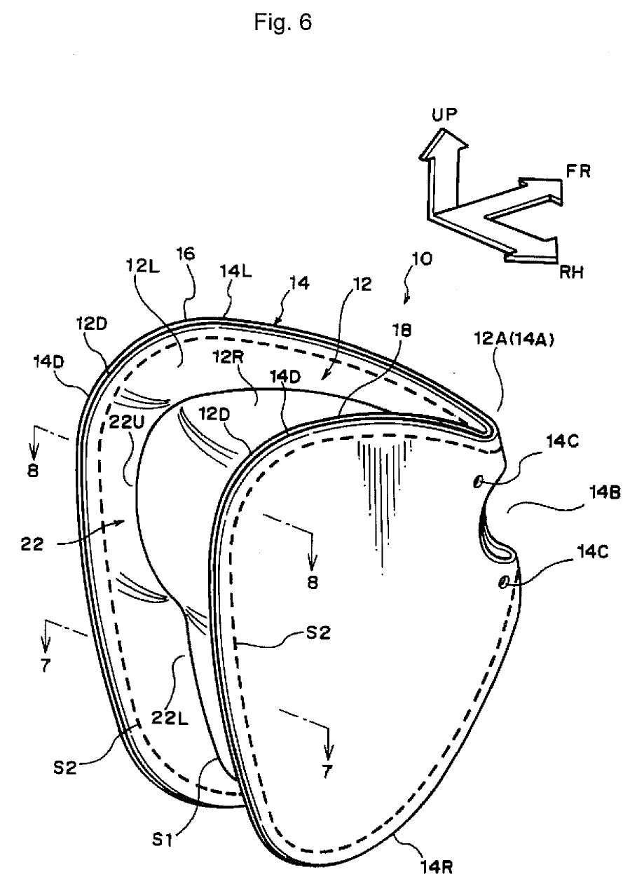

As shown in FIG. 6, the outer panel 14 is sewn (sewn portion S2) along the outer peripheral edge portion 12D of the inner panel 12 that is folded in two. Concretely, the outer panel 14 is folded in two toward the passenger side (the vehicle rear side) with the central portion 14A being the center, and a 14D of the left side base cloth 14L at the outer panel 14 is superposed on the outer peripheral edge portion 12D of the left side base cloth 12L at the inner panel 12, and further, the 14D of the right side base cloth 14R at the outer panel 14 is superposed on the outer peripheral edge portion 12D of the right side base cloth 12R at the inner panel 12. Then, the outer peripheral edge portion 12D of the inner panel 12 and the outer peripheral edge portion 14D of the outer panel 14 are sewn at the sewn portion S2.

As shown in FIG. 2, in the unfolded state before sewing of the inner panel 12, the position of the sewing line S1 is set at the inner side of the sewn portion 52. Due thereto, as shown in Fig. I and FIG. 6, at the time of inflation and deployment of the airbag 10 for a front passenger's seat, a concave portion 22 is formed between the left side bag portion 16 and the right side bag portion 18 at the passenger side (the vehicle rear side). The depth of this concave portion 22 is set to be larger at vehicle lower region 22L than at a vehicle upper region 22U.

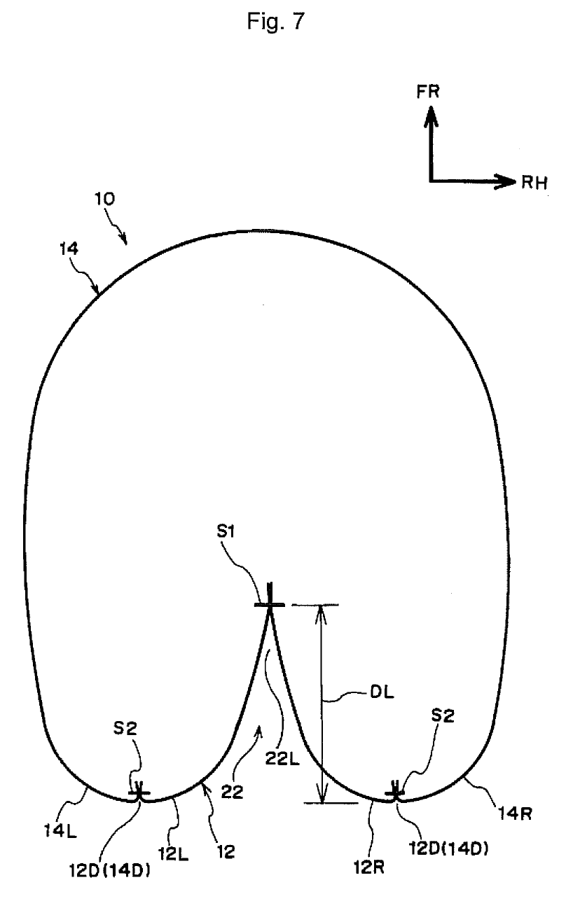

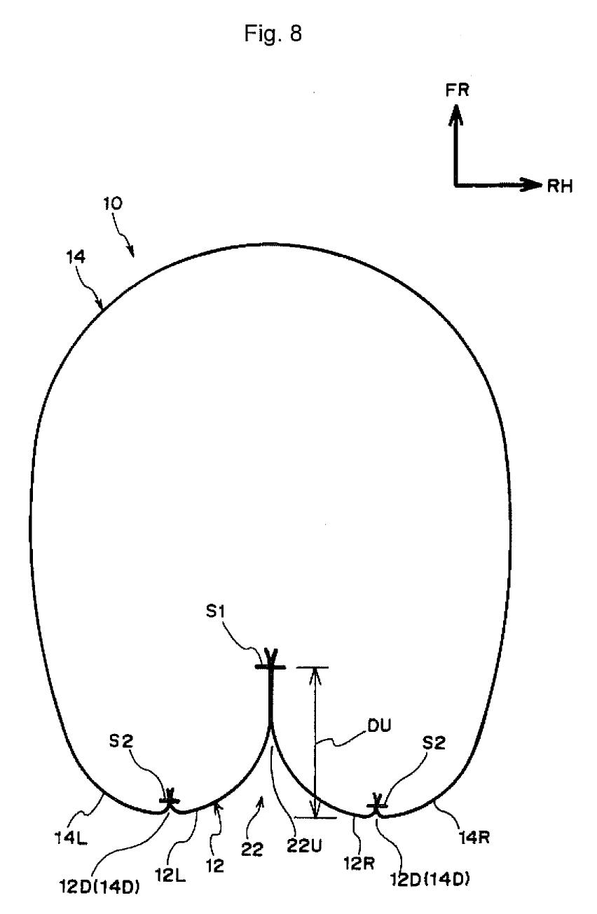

Here, the depth of the concave portion 22 is the distance, in the vehicle front-rear direction, from the outer peripheral edge portions 12D, 14D to the sewing line S1. Accordingly, in the present embodiment, a depth DL (FIG. 7) of the concave portion 22 at the vehicle lower region 22L is set to be greater than a depth DU (FIG. 8) of the concave portion 22 at the vehicle upper region 22U. Concretely, the depth DU is set to, for example, 20 to 40 mm, and the depth DL is set to, for example, 40 to 60 mm which is greater than the depth DU.

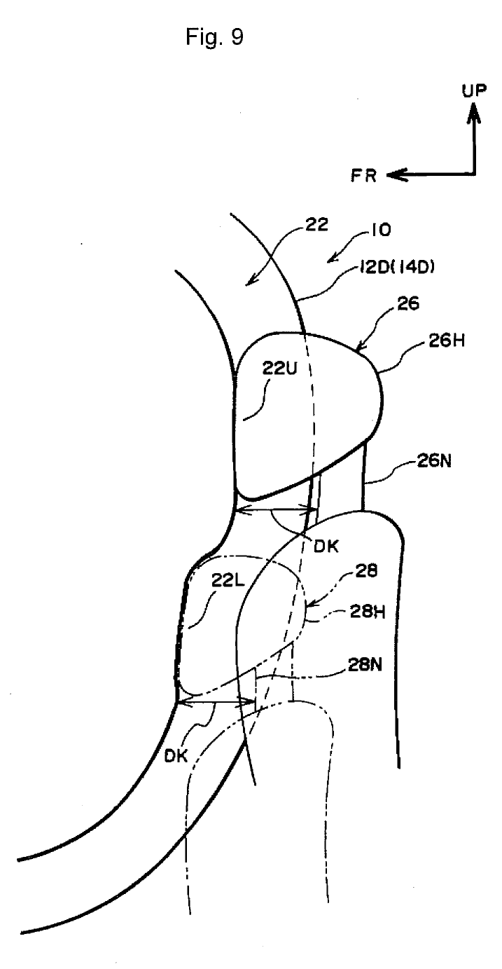

As shown in FIG. 9, the height position of the vehicle upper region 22U is set so as to correspond to the height position of a head portion 26H of a seated passenger 26 of a large build, e.g., the head portion of an AM50 (50^{th} percentile adult male) dummy. Further, the vehicle lower region 22L is set so as to correspond to the height position of a head portion 28H of a seated passenger 28 of a small build, e.g., the head portion of an AF05 (5^{th} percentile adult female) dummy.

As shown in FIG. 1, the airbag 10 for a front passenger's seat is, together with an unillustrated inflator, stored within an instrument panel 24 of the vehicle. The inflator is electrically connected to an unillustrated airbag ECU.

Note that the inner panel 12 and the outer panel 14 are each made to be a single base cloth, but are not limited to this, and, for example, each may be a pair of left and right base cloths. Further, as the base cloths that structure the airbag 10 for a front passenger's seat, a reinforcing cloth or the like may be added appropriately in addition to the inner panel 12 and the outer panel 14.

(Operation)

The present embodiment is structured as described above, and the operation thereof is described hereinafter. In FIG. 1, the airbag 10 for a front passenger's seat relating to the present embodiment is structured by using the inner panel 12 (FIG. 2) and the outer panel (FIG. 4) that are each a single base cloth, and is structured by these being sewn. Therefore, the number of panels can be suppressed, and the structure can be simplified. Further, because the respective sewings can be carried out in a plane, the sewing work is easy. Therefore, the manufacturing cost can be greatly reduced.

As shown in FIG. 2, the lateral hole 12C is formed in the inner panel 12, and the sewing line S1 is set at the region between this lateral hole 12C and the outer peripheral edge portion 12D. Therefore, the used amount of the base cloth that structures the inner panel 12 is reduced, the manufacturing cost is reduced more, and the folded-up dimension at usual times is made to be small, and the loadability into a vehicle can be improved.

As shown in FIG. 1 and FIG. 6, at the airbag 10 for a front passenger's seat at the time of inflation and deployment, the concave portion 22 is formed at the passenger side between the left side bag portion 16 and the right side bag portion 18. The shape of this concave portion 22 can be set arbitrarily by the sewing line S1 of sewing together the inner panel 12 at the time of manufacturing the airbag 10 for a front passenger's seat. Therefore, many types of airbags corresponding to vehicles can be manufactured by merely changing the sewing line, while using the panels in common.

Next, operation at the time of inflation and deployment of the airbag 10 for a front passenger's seat is described. When the airbag ECU judges the occurrence of a side collision on the basis of a signal from a collision sensor, ignition current is made to flow from the airbag ECU to the inflator. Due thereto, the inflator operates, and a large amount of gas is generated. As shown in FIG. 1, the airbag 10 for a front passenger's seat receives the supply of this gas, and inflates and deploys from within the instrument panel 24 toward the passenger 26, 28 (FIG. 9) side.

In FIG. 1, the head portion 26H, 28H (FIG. 9) of the passenger 26, 28 enters into and is restrained by, of the airbag 10 for a front passenger's seat that is inflated and deployed, the concave portion 22 at the passenger 26 side between the left side bag portion 16 and the right side bag portion 18. Further, the left shoulder (not shown) of the passenger 26, 28 is restrained by the left side bag portion 16, and the right shoulder (not shown) is restrained by the right side bag portion 18. Due thereto, the passenger 26, 28 is stably restrained by the airbag 10 for a front passenger's seat.

As shown in FIG. 1 and from FIG. 6 to FIG. 8, the depth of the concave portion 22 at the time of inflation and deployment differs at the vehicle vertical direction positions, and is set to be greater at the vehicle lower region 22L than at the vehicle upper region 22U. Accordingly, the passenger 26 of a large build who is shown by the solid lines in FIG. 9 is restrained by the portion of the concave portion 22 that is relatively shallow (the vehicle upper region 22U). On the other hand, the passenger 28 of a small build who is shown by the two-dot chain lines in FIG. 9 is restrained by the portion of the concave portion 22 that is relatively deep (the vehicle lower region 22L). Due thereto, the force of restraining the passenger 28 of a small build can be suppressed while the force of restraining the passenger 26 of a large build is sufficiently ensured. Therefore, the passenger 26, 28 can be restrained appropriately in accordance with the build of the passenger 26, 28.

Note that the passenger 26 shown by the solid lines in FIG. 9 is, for example, an AM50 (50^{th} percentile adult male) dummy, and the passenger 28 shown by the two-dot chain lines is, for example, an AF05 (5^{th} percentile adult female) dummy.

Further, a distance DK from a neck portion 26N, 28N of the passenger 26, 28 at the time of restraining the passenger to the base cloth (the inner panel 12) that is at the vehicle front side of the neck portion 26N, 28N is desirably ensured to be at least 60 mm. This is in order to be able to suppress application of restraining force to the neck portion 26N from the inner panel 12.

As shown in FIG. 5, when the inner surface of the left side base cloth 14L and the inner surface of the right side base cloth 14R at the outer panel 14 are connected by the restricting member 20, the amount of inflation and deployment of the vehicle transverse inflation at the time of inflation is restricted by this restricting member 20. Therefore, the airbag 10 for a front passenger's seat can be inflated and deployed appropriately toward the passenger side while conserving the amount of gas that is supplied.

### DESCRIPTION OF REFERENCE NUMERALS

10 airbag for front passenger's seat
12 inner panel
12A central portion
12C lateral hole
12D outer peripheral edge portion
14 outer panel
14A central portion
14B gas supply opening
16 left side bag portion
18 right side bag portion
20 restricting member
22 concave portion
22L vehicle lower region
22U vehicle upper region
26 passenger
28 passenger
S1 sewing line

1. An airbag for a front passenger's seat, the airbag structured by using an inner panel that is sewn together opposingly in a vehicle transverse direction, and an outer panel that is provided so as to nip the inner panel from both sides in the vehicle transverse direction, wherein
a left side bag portion that is positioned at a vehicle transverse direction left side, and a right side bag portion that is positioned at a vehicle transverse direction right side, are provided,
a shape of a concave portion at a passenger side between the left side bag portion and the right side bag portion is set by a sewing line of sewing together the inner panel,
the inner panel is a single base cloth, and is folded in two toward the passenger side with a central portion in the vehicle transverse direction being a center, and a left side base cloth, that is positioned at a vehicle transverse direction left side, and a right side base cloth, that is positioned at a vehicle transverse direction right side, are sewn along the sewing line in a state of opposing one another in the vehicle transverse direction,
the outer panel is a single base cloth that has an outer shape corresponding to the inner panel and in whose central portion a gas supply opening for inflation is formed, and is sewn along an outer peripheral edge portion of the inner panel that is folded in two, and
a depth of the concave portion at the passenger side at a time of inflation and expansion is a distance, in a vehicle front-back direction, from outer peripheral edge portions of the inner panel and the outer panel to the sewing line, and is set to be greater at a vehicle lower region than at a vehicle upper region.

2. (canceled)

3. The airbag for a front passenger's seat of claim 1, wherein
a lateral hole that is long in a left-right direction is formed in a central portion, in the
vehicle transverse direction, of the inner panel in an unfolded state before sewing, and the sewing line is set at a region between the lateral hole and the outer peripheral edge portion.

4. The airbag for a front passenger's seat of claim 3, wherein an inner surface of a vehicle transverse direction left side and an inner surface of a vehicle transverse direction right side at the outer panel are connected by a restricting member that restricts an amount of inflation and expansion in the vehicle transverse direction.

5. (canceled)
